(19) United States
(12) Patent Application Publication
(10) Pub. No.: US 2007/0256133 A1
(43) Pub. Date: Nov. 1, 2007

(54) BLOCKING PROCESSES FROM EXECUTING BASED ON VOTES

(76) Inventors: Zachary Adam Garbow, Rochester, MN (US); Michael Anthony Nelson JR., Kansas City, MO (US); Kevin Glynn Paterson, San Antonio, TX (US)

Correspondence Address: IBM CORPORATION;ROCHESTER IP LAW DEPT. 917, 3605 HIGHWAY 52 NORTH, ROCHESTER, MN, 55901-7829, US

(21) Appl. No.: 11/380,442

(22) Filed: Apr. 27, 2006

(51) Int. Cl. H04L 9/32; H04N 7/16; H04L 9/00; G06K 9/00; G06F 17/30; G06F 7/04; G06F 15/16; H03M 1/68; G06F 7/58; H04K 1/00; G06K 19/00

(52) U.S. Cl. 726/26; 726/27; 726/2; 726/4; 713/165; 713/167

(57) ABSTRACT

In an embodiment, in response to detecting that a process is attempting to execute at the client, a vote for the process is requested from a user if the user has not yet provided a vote. In various embodiments, the vote is an opinion of whether execution of the process at the client is harmful or an opinion of a category to which the process belongs. In an embodiment, an aggregation of votes from other users is also presented. The votes of other users are provided by other clients where the process also attempted to execute. The aggregation of votes may be categorized by communities to which the users belong. In an embodiment, a decision is requested of whether to allow the process to execute, and a rule is created based on the decision. The process is blocked from executing if the process satisfies a rule indicating that the process is to be blocked. The process is allowed to execute if the process satisfies a rule indicating that the process is to execute. In an embodiment, the rule that allows the process to execute has a condition which is enforced, such as logging actions of the process or denying network access by the process.

### FIELD

An embodiment of the invention generally relates to computers. In particular, an embodiment of the invention generally relates to blocking processes from executing at a client based on votes for the processes at other clients.

### BACKGROUND

The development of the EDVAC computer system of 1948 is often cited as the beginning of the computer era. Since that time, computer systems have evolved into extremely sophisticated devices, and computer systems may be found in many different settings. Computer systems typically include a combination of hardware, such as semiconductors and circuit boards, and software, also known as computer programs.

Years ago, computers were isolated devices that did not communicate with each other. But, today computers are often connected in networks, such as the Internet or World Wide Web, and a user at one computer, often called a client, may wish to access information at multiple other computers, often called servers, via a network. Although this connectivity can be of great benefit to authorized users, it also provides an opportunity for unauthorized persons (often called intruders, attackers, or hackers) to access, break into, or misuse computers that might be thousands of miles away through the use of malicious programs.

A malicious program may be any harmful, unauthorized, or otherwise dangerous computer program or piece of code that “infects” a computer and performs undesirable activities in the computer. Some malicious programs are simply mischievous in nature. But, others can cause a significant amount of harm to a computer and/or its user, including stealing private data, deleting data, clogging the network with many emails or transmissions, and/or causing a complete computer failure. Some malicious programs even permit a third party to gain control of a user's computer outside of the knowledge of the user, while others may utilize a user's computer in performing malicious activities such as launching denial-of-service attacks against other computers.

Malicious programs can take a wide variety of forms, such as viruses, Trojan horses, worms, spyware, adware, or logic bombs. Malicious programs can be spread in a variety of manners, such as email attachments, macros, or scripts. Often, a malicious program will hide in, or “infect,” an otherwise healthy computer program, so that the malicious program will be activated when the infected computer program is executed. Malicious programs often have the ability to replicate and spread to other computer programs, as well as other computers.

To address the risks associated with malicious programs, significant efforts have been directed toward the development of computer programs that attempt to detect and/or remove viruses and other malicious programs that attempt to infect a computer. Such efforts have resulted in a continuing competition where virus creators continually attempt to create increasingly sophisticated viruses, and anti-virus developers continually attempt to protect computers from new viruses.

One capability of many conventional anti-virus programs is the ability to perform virus checking on virus-susceptible computer files after the files have been received and stored in a computer, e.g., after downloading emails or executable files from the Internet. Server-based anti-virus programs are also typically used to virus check the files accessible by a server. Such anti-virus programs, for example, are often used by web sites for internal purposes, particularly download sites that provide user access to a large number of downloadable executable files that are often relatively susceptible to viruses.

Several well-accepted methods exist for detecting computer viruses in memory, programs, documents or other potential hosts that might harbor them. One popular method is called “scanning.” A scanner searches (or scans) the potential hosts for a set of one or more (typically several thousand) specific patterns of code called “signatures” that are indicative of particular known viruses or virus families, or that are likely to be included in new viruses. A signature typically consists of a pattern to be matched, along with implicit or explicit auxiliary information about the nature of the match and possibly transformations to be performed upon the input data prior to seeking a match to the pattern. The pattern could be a byte sequence to which an exact or inexact match is to be sought in the potential host. Unfortunately, the scanner must know the signature in order to detect the virus, and malicious persons are continually developing new viruses with new signatures, of which the scanner may have no knowledge.

In an attempt to overcome this problem, other techniques of virus detection have been developed that do not rely on prior knowledge specific signatures. These methods include monitoring memory or intercepting various system calls in order to monitor for virus-like behaviors, such as attempts to run programs directly from the Internet without downloading them first, changing program codes, or remaining in memory after execution. Another technique for protecting a computer from malicious programs is called a firewall. Most firewalls today rely on the user to determine which programs are good and which ones are harmful. The firewall prompts the user when an unrecognized source is trying to access their computer. The user can choose to grant access or block access to their computer. Unfortunately, users often experience great difficulty in making these decisions because the abstract wording of the prompts or the names of the viruses or spyware programs can lead users to believe that they need to allow access to their computer so that they can continue running a program, or load the next web page. Thus, a malicious program might be allowed to access the computer because the user is unaware that the source is actually a virus or spyware program.

Hence, a need exists for a technique that more easily and effectively distinguishes between useful and harmful programs, in order to save users and businesses time and money in detecting and recovering from malicious programs.

### SUMMARY

A method, apparatus, system, and signal-bearing medium are provided. In an embodiment, in response to detecting that a process is attempting to execute at the client, a vote for the process is requested from a user if the user has not yet provided a vote. In various embodiments, the vote is an opinion of whether execution of the process at the client is harmful or an opinion of a category to which the process belongs. In an embodiment, an aggregation of votes from other users is also presented. The votes of other users are provided by other clients where the process also attempted to execute. The aggregation of votes may be categorized by communities to which the users belong. In an embodiment, a decision is requested of whether to allow the process to execute, and a rule is created based on the decision. The process is blocked from executing if the process satisfies a rule indicating that the process is to be blocked. The process is allowed to execute if the process satisfies a rule indicating that the process is to execute. In an embodiment, the rule that allows the process to execute has a condition which is enforced, such as logging actions of the process or denying network access by the process. In an embodiment, an aggregation of tag data generated at clients in response to saving a file is used to create the rule. Example tag data includes a source type of the file, an identifier of the source of the file, and runtime data of the process that saved the file.

### BRIEF DESCRIPTION OF THE DRAWING

FIG. 1 depicts a block diagram of an example system for implementing an embodiment of the invention.

FIG. 2 depicts a block diagram of select components of an example network of systems for implementing an embodiment of the invention.

FIG. 3 depicts a block diagram of an example user interface, according to an embodiment of the invention.

FIG. 4 depicts a block diagram of an example data structure for community data, according to an embodiment of the invention.

FIG. 5 depicts a block diagram of an example data structure for an aggregation of user vote data, according to an embodiment of the invention.

FIG. 6 depicts a block diagram of an example data structure for an aggregation of system-generated tag data, according to an embodiment of the invention.

FIG. 7 depicts a block diagram of example rules, according to an embodiment of the invention.

FIG. 8A depicts a flowchart of example processing for a firewall that has detected a process attempting to execute, according to an embodiment of the invention.

FIG. 8B depicts a flowchart of further example processing for a firewall that has detected a process attempting to execute, according to an embodiment of the invention.

FIG. 9 depicts a flowchart of example processing in response to detecting the saving of a file, according an embodiment of the invention.

FIG. 10 depicts a flowchart of example processing in response to receiving user vote data, according an embodiment of the invention.

### DETAILED DESCRIPTION

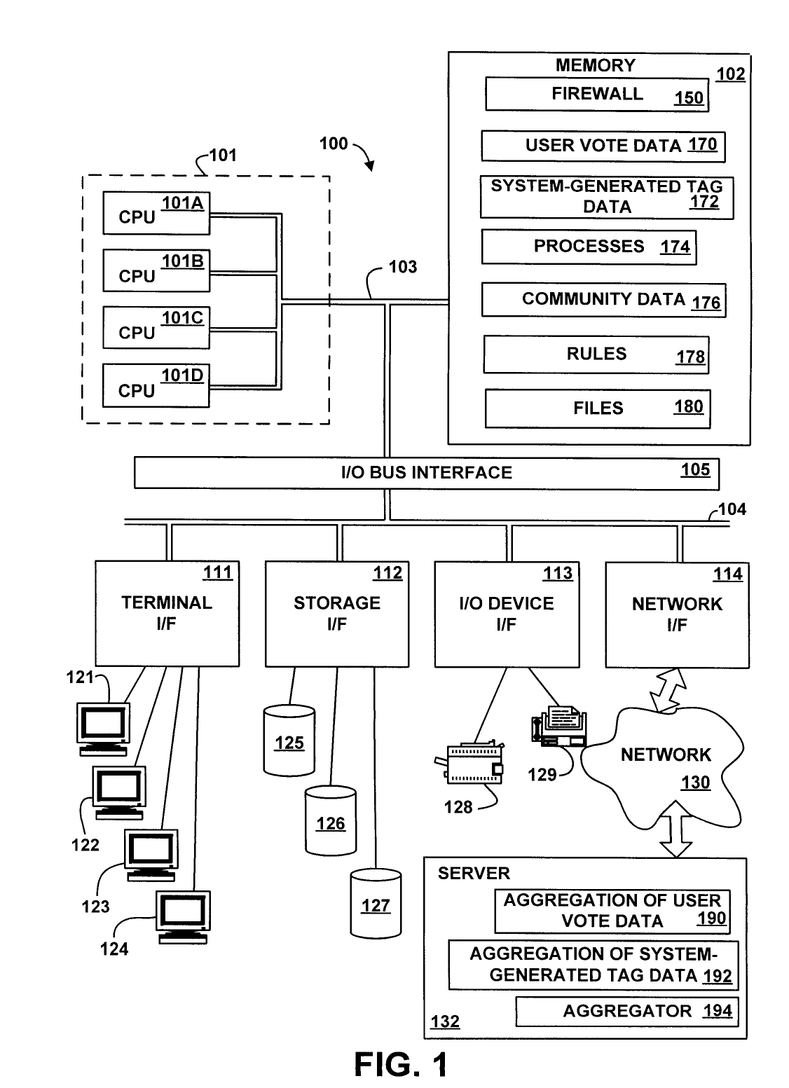

Referring to the Drawings, wherein like numbers denote like parts throughout the several views, FIG. 1 depicts a high-level block diagram representation of a client computer system 100 connected via a network 130 to a server computer system 132, according to an embodiment of the present invention. The terms “client” and “server” are used herein for convenience only, and a computer system that operates as a client in one scenario may operate as a server in another scenario, and vice versa. The major components of the client computer system 100 include one or more processors 101, a main memory 102, a terminal interface 111, a storage interface 112, an I/O (Input/Output) device interface 113, and communications/network interfaces 114, all of which are coupled for inter-component communication via a memory bus 103, an I/O bus 104, and an I/O bus interface unit 105.

The client computer system 100 contains one or more general-purpose programmable central processing units (CPUs) 101A, 101B, 101C, and 101D, herein generically referred to as the processor 101. In an embodiment, the client computer system 100 contains multiple processors typical of a relatively large system; however, in another embodiment the client computer system 100 may alternatively be a single CPU system. Each processor 101 executes instructions stored in the main memory 102 and may include one or more levels of on-board cache.

The main memory 102 is a random-access semiconductor memory for storing data and programs. The main memory 102 is conceptually a single monolithic entity, but in other embodiments, the main memory 102 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may further be distributed and associated with different CPUs or sets of CPUs, as is known in any of various so-called non-uniform memory access (NUMA) computer architectures.

The memory 102 includes a firewall 150, user vote data 170, system-generated tag data 172, processes 174, community data 176, rules 178, and files 180. Although the firewall 150, the user vote data 170, the system-generated tag data 172, the processes 174, the community data 176, the rules 178, and the files 180 are illustrated as being contained within the memory 102 in the client computer system 100, in other embodiments some or all of them may be on different computer systems and may be accessed remotely, e.g., via the network 130. The client computer system 100 may use virtual addressing mechanisms that allow the programs of the client computer system 100 to behave as if they only have access to a large, single storage entity instead of access to multiple, smaller storage entities. Thus, while the firewall 150, the user vote data 170, the system-generated tag data 172, the processes 174, the community data 176, the rules 178, and the files 180 are all illustrated as being contained within the memory 102 in the client computer system 100, these elements are not necessarily all completely contained in the same storage device at the same time. Further, although the firewall 150, the user vote data 170, the system-generated tag data 172, the processes 174, the community data 176, the rules 178, and the files 180 are illustrated as being separate entities, in other embodiments some of them, portions of some of them, or all of them may be packaged together.

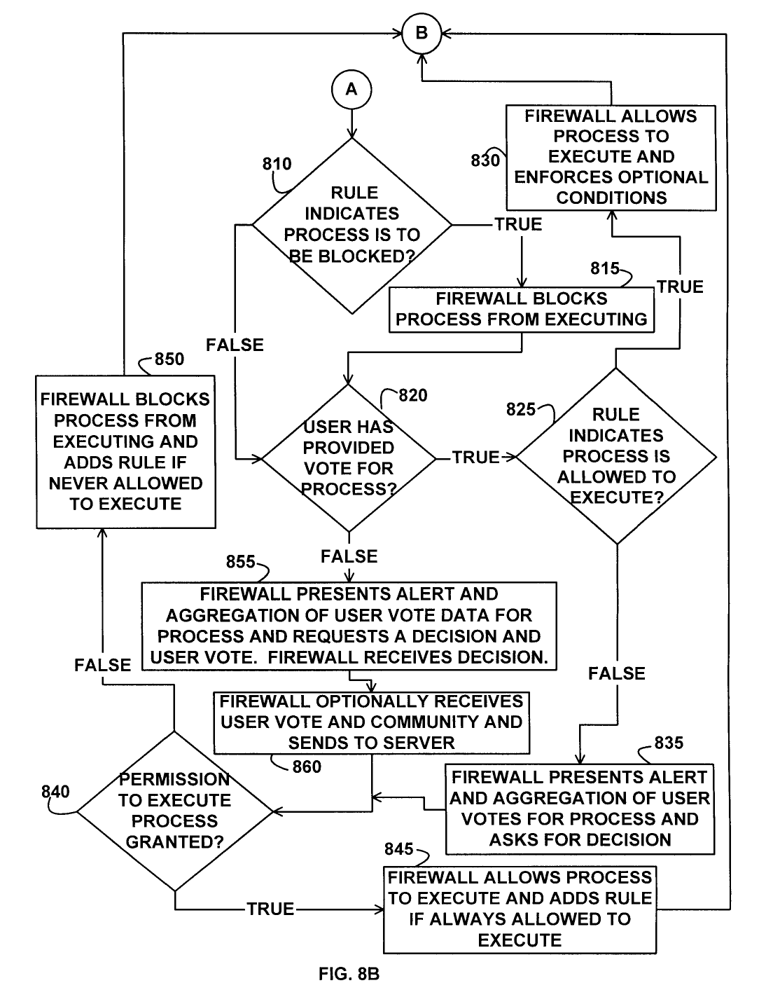

The firewall 150 provides security against unauthorized or harmful processes. In an embodiment, the firewall 150 includes instructions capable of executing on the processor 101 or statements capable of being interpreted by instructions executing on the processor 101 to perform the functions as further described below with reference to FIGS. 8A, 8B, 9, and 10. In another embodiment, the firewall 150 may be implemented in microcode. In another embodiment, the firewall 150 may be implemented in hardware via logic gates and/or other appropriate hardware techniques in lieu of or in addition to a processor-based system.

The processes 174 include instructions capable of executing on the processor 101 or statements, control tags, or registry values capable of being interpreted by or used to control instructions executing on the processor 101. The processes 174 may be authorized and beneficial processes (such as applications or operating systems) or may be harmful processes, such as viruses, worms, Trojan horses, adware, spyware, or logic bombs. In an embodiment, processes may be embedded in each other. For example, a legitimate and authorized process (e.g., an email application) may be embedded with a harmful process (e.g. a virus that causes the email application to malfunction).

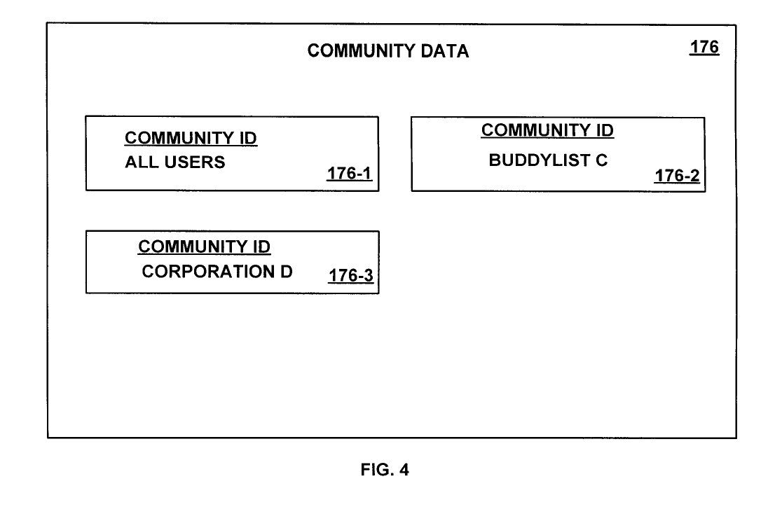

The user vote data 170 includes votes of users with respect to the processes 174. A vote represents an opinion of whether execution of the process 174 on the processor 101 is harmful or an opinion of the category to which the process 174 belongs (e.g., a virus, spyware, or authorized application). The community data 176 specifies communities, groups, or sets to which the user or the client computer system 100 may belong. The community data 176 is used to categorize the votes of the user when submitting the votes to the server 132. The community data 176 is further described below with reference to FIG. 4.

The firewall 150 generates the system-generated tag data 172 in response to detecting the saving of the files 180 at the client computer system 100. The system-generated tag data 172 characterizes the saved files 180 and the processes 174 that saved them. In various embodiments, the files 180 may be flat files, registries, directories, sub-directories, folders, databases, records, fields, columns, rows, data structures, any other technique for storing data and/or code, or any portion, combination, or multiple thereof.

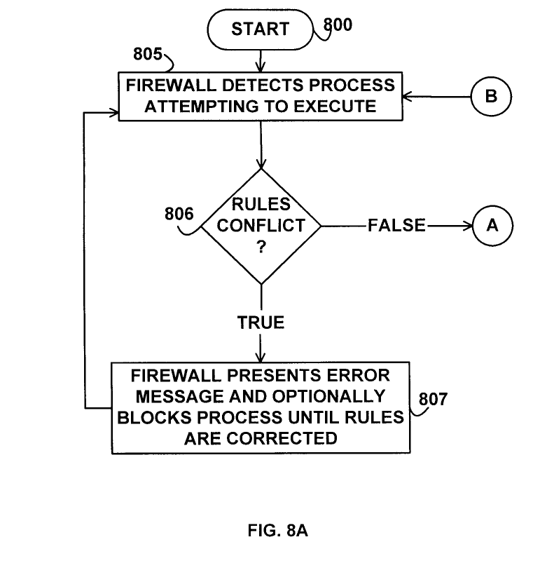

The rules 178 specify criteria for deciding whether the processes 174 should be allowed to execute or should be blocked from executing on the processor 101. The rules 178 are further described below with reference to FIG. 7.

The memory bus 103 provides a data communication path for transferring data among the processors 101, the main memory 102, and the I/O bus interface unit 105. The I/O bus interface unit 105 is further coupled to the system I/O bus 104 for transferring data to and from the various I/O units. The I/O bus interface unit 105 communicates with multiple I/O interface units 111, 112, 113, and 114, which are also known as I/O processors (IOPs) or I/O adapters (IOAs), through the system I/O bus 104. The system I/O bus 104 may be, e.g., an industry standard PCI (Peripheral Component Interconnect) bus, or any other appropriate bus technology. The I/O interface units support communication with a variety of storage and I/O devices. For example, the terminal interface unit 111 supports the attachment of one or more user terminals 121, 122, 123, and 124.

The storage interface unit 112 supports the attachment of one or more direct access storage devices (DASD) 125, 126, and 127, which are typically rotating magnetic disk drive storage devices, although they could alternatively be other devices, including arrays of disk drives configured to appear as a single large storage device to a host. The contents of the DASD 125, 126, and 127 may be loaded from and stored to the memory 102 as needed. The storage interface unit 112 may also support other types of devices, such as a diskette device, a tape device, an optical device, or any other type of storage device.

The I/O device interface 113 provides an interface to any of various other input/output devices or devices of other types. Two such devices, the printer 128 and the fax machine 129, are shown in the exemplary embodiment of FIG. 1, but in other embodiment many other such devices may exist, which may be of differing types.

The network interface 114 provides one or more communications paths from the client computer system 100 to other digital devices and computer systems; such paths may include, e.g., one or more networks 130. In various embodiments, the network interface 114 may be implemented via a modem, a LAN (Local Area Network) card, a virtual LAN card, or any other appropriate network interface or combination of network interfaces.

Although the memory bus 103 is shown in FIG. 1 as a relatively simple, single bus structure providing a direct communication path among the processors 101, the main memory 102, and the I/O bus interface 105, in fact the memory bus 103 may comprise multiple different buses or communication paths, which may be arranged in any of various forms, such as point-to-point links in hierarchical, star or web configurations, multiple hierarchical buses, parallel and redundant paths, etc. Furthermore, while the I/O bus interface 105 and the I/O bus 104 are shown as single respective units, the client computer system 100 may in fact contain multiple I/O bus interface units 105 and/or multiple I/O buses 104. While multiple I/O interface units are shown, which separate the system I/O bus 104 from various communications paths running to the various I/O devices, in other embodiments some or all of the I/O devices are connected directly to one or more system I/O buses.

The client computer system 100 depicted in FIG. 1 has multiple attached terminals 121, 122, 123, and 124, such as might be typical of a multi-user “mainframe” computer system. Typically, in such a case the actual number of attached devices is greater than those shown in FIG. 1, although the present invention is not limited to systems of any particular size. The client computer system 100 may alternatively be a single-user system, typically containing only a single user display and keyboard input, or might be a server or similar device which has little or no direct user interface, but receives requests from other computer systems (clients). In other embodiments, the client computer system 100 may be implemented as a firewall, router, Internet Service Provider (ISP), personal computer, portable computer, laptop or notebook computer, PDA (Personal Digital Assistant), tablet computer, pocket computer, telephone, pager, automobile, teleconferencing system, appliance, or any other appropriate type of electronic device.

The network 130 may be any suitable network or combination of networks and may support any appropriate protocol suitable for communication of data and/or code to/from the client computer system 100. In various embodiments, the network 130 may represent a storage device or a combination of storage devices, either connected directly or indirectly to the client computer system 100. In an embodiment, the network 130 may support Infiniband. In another embodiment, the network 130 may support wireless communications. In another embodiment, the network 130 may support hard-wired communications, such as a telephone line or cable. In another embodiment, the network 130 may support the Ethernet IEEE (Institute of Electrical and Electronics Engineers) 802.3x specification. In another embodiment, the network 130 may be the Internet and may support IP (Internet Protocol). In another embodiment, the network 130 may be a local area network (LAN) or a wide area network (WAN). In another embodiment, the network 130 may be a hotspot service provider network. In another embodiment, the network 130 may be an intranet. In another embodiment, the network 130 may be a GPRS (General Packet Radio Service) network. In another embodiment, the network 130 may be a FRS (Family Radio Service) network. In another embodiment, the network 130 may be any appropriate cellular data network or cell-based radio network technology. In another embodiment, the network 130 may be an IEEE 802.11B wireless network. In still another embodiment, the network 130 may be any suitable network or combination of networks. Although one network 130 is shown, in other embodiments any number of networks (of the same or different types) may be present.

The server computer system 132 may include any or all of the components previously described above for the client computer system 100. Although the server computer system 132 is illustrated as being a separate computer system from the client 100 and connected via the network 130, in another embodiment the server computer system 132 and the client 100 may be implemented via the same computer system, and may be implemented, e.g., as different programs within the memory 102. The server computer system 132 further includes an aggregation of user vote data 190, an aggregation of system-generated tag data 192, and an aggregator 194.

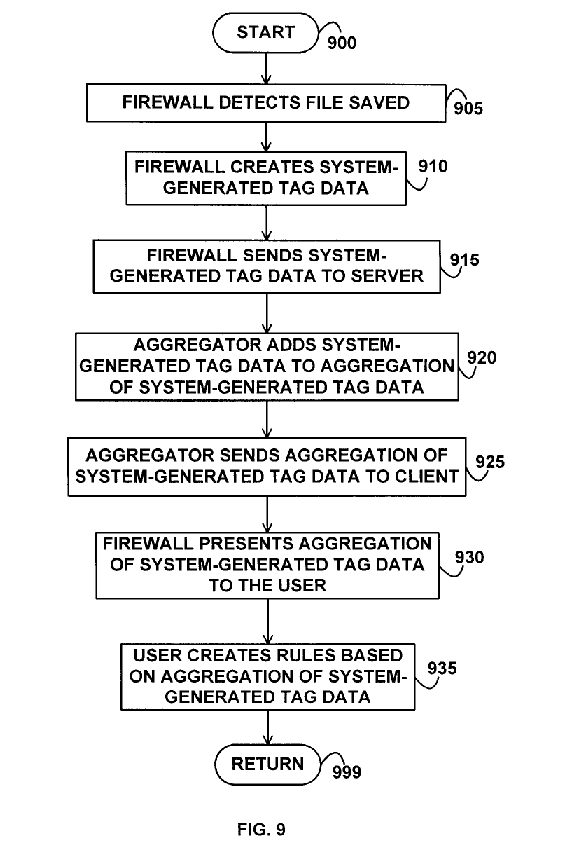

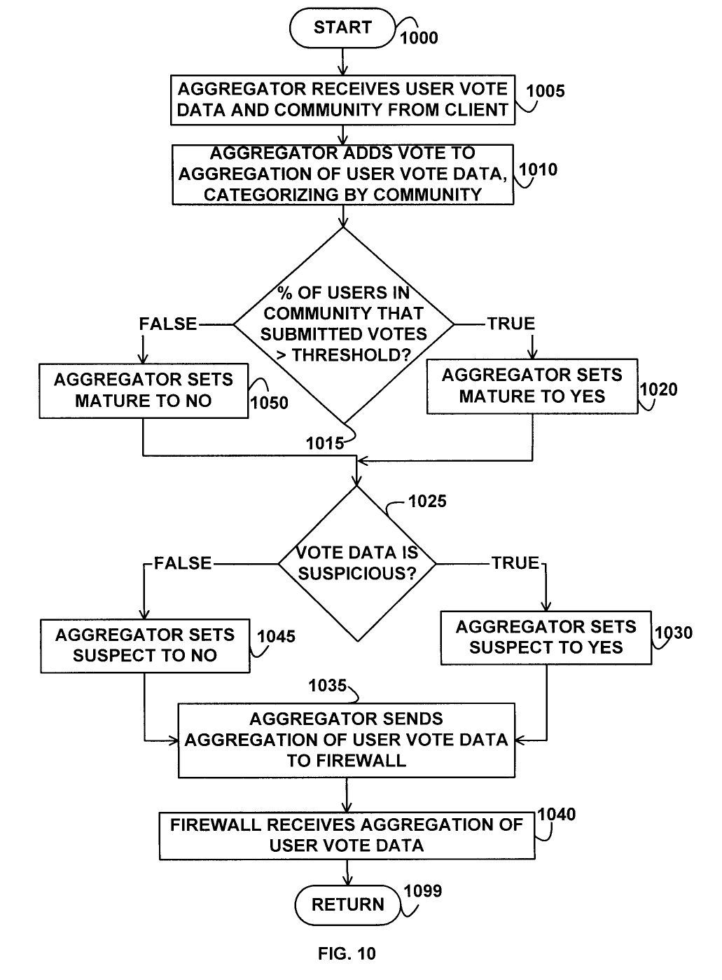

The aggregator 194 aggregates the user vote data 170 and the system-generated tag data 172 from multiple clients 100 into the aggregation of user vote data 190 and aggregation of system-generated tag data 192, respectively. In an embodiment, the aggregator 194 includes instructions capable of executing on a processor analogous to the processor 101 or statements capable of being interpreted by instructions executing on the processor to perform the functions as further described below with reference to FIGS. 9 and 10. In another embodiment, the aggregator 194 may be implemented in microcode. In another embodiment, the aggregator 194 may be implemented in hardware via logic gates and/or other appropriate hardware techniques in lieu of or in addition to a processor-based system.

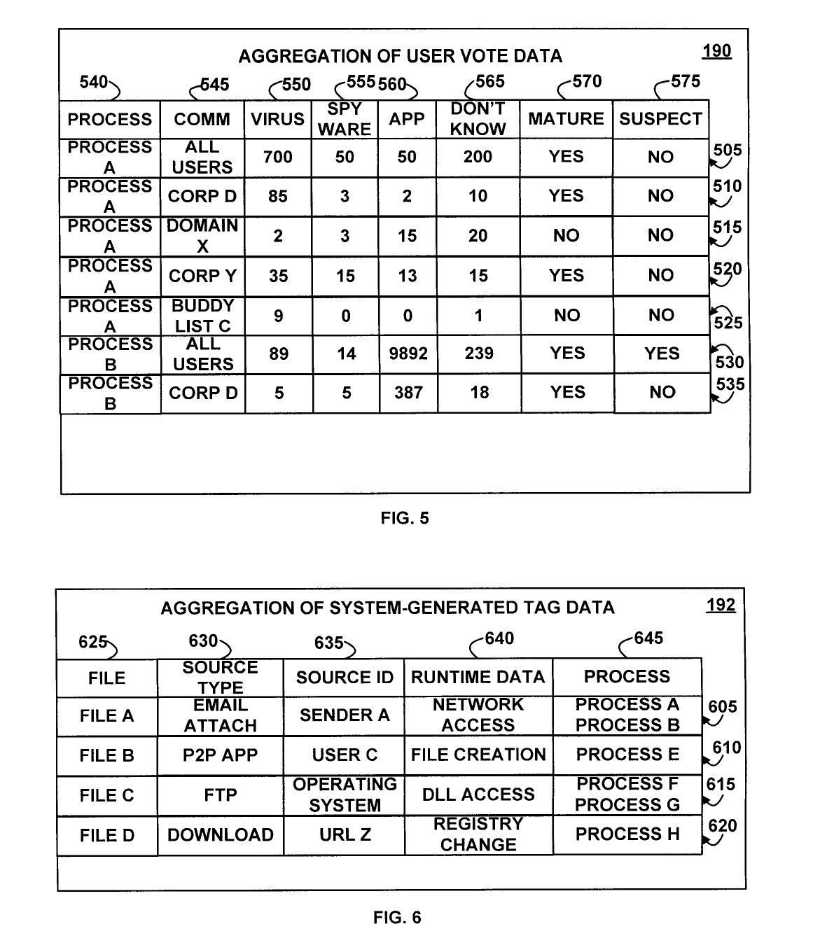

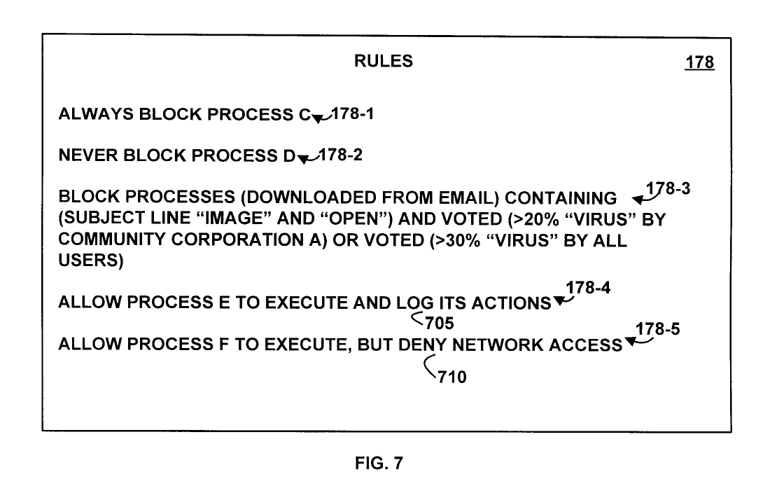

The aggregation of user vote data 190 is further described below with reference to FIG. 5. The aggregation of system-generated tag data 192 is further described below with reference to FIG. 6.

It should be understood that FIG. 1 is intended to depict the representative major components of the client computer system 100, the network 130, and the server computer system 132 at a high level, that individual components may have greater complexity than represented in FIG. 1, that components other than, fewer than, or in addition to those shown in FIG. 1 may be present, and that the number, type, and configuration of such components may vary. Several particular examples of such additional complexity or additional variations are disclosed herein; it being understood that these are by way of example only and are not necessarily the only such variations.

The various software components illustrated in FIG. 1 and implementing various embodiments of the invention may be implemented in a number of manners, including using various computer software applications, routines, components, programs, objects, modules, data structures, etc., referred to hereinafter as “computer programs,” or simply “programs.” The computer programs typically comprise one or more instructions that are resident at various times in various memory and storage devices in the client computer system 100 and/or the server computer system 132, and that, when read and executed by one or more processors in the client computer system 100 and the server computer system 132, cause the client computer system 100 and/or the server computer system 132 to perform the steps necessary to execute steps or elements embodying the various aspects of an embodiment of the invention.

Moreover, while embodiments of the invention have and hereinafter will be described in the context of fully functioning computer systems, the various embodiments of the invention are capable of being distributed as a program product in a variety of forms, and the invention applies equally regardless of the particular type of signal-bearing medium used to actually carry out the distribution. The programs defining the functions of this embodiment may be delivered to the client computer system 100 and the server computer system 132 via a variety of tangible signal-bearing media that may be operatively or communicatively connected (directly or indirectly) to the processor 101. The signal-bearing media may include, but are not limited to:

(1) information permanently stored on a non-rewriteable storage medium, e.g., a read-only memory device attached to or within a computer system, such as a CD-ROM readable by a CD-ROM drive;

(2) alterable information stored on a rewriteable storage medium, e.g., a hard disk drive (e.g., DASD 125, 126, or 127), CD-RW, or diskette; or

(3) information conveyed to the client computer system 100 by a communications medium, such as through a computer or a telephone network, e.g., the network 130.

Such tangible signal-bearing media, when encoded with or carrying computer-readable and executable instructions that direct the functions of the present invention, represent embodiments of the present invention.

Embodiments of the present invention may also be delivered as part of a service engagement with a client corporation, nonprofit organization, government entity, internal organizational structure, or the like. Aspects of these embodiments may include configuring a computer system to perform, and deploying software systems and web services that implement, some or all of the methods described herein. Aspects of these embodiments may also include analyzing the client company, creating recommendations responsive to the analysis, generating software to implement portions of the recommendations, integrating the software into existing processes and infrastructure, metering use of the methods and systems described herein, allocating expenses to users, and billing users for their use of these methods and systems.

In addition, various programs described hereinafter may be identified based upon the application for which they are implemented in a specific embodiment of the invention. But, any particular program nomenclature that follows is used merely for convenience, and thus embodiments of the invention should not be limited to use solely in any specific application identified and/or implied by such nomenclature.

The exemplary environments illustrated in FIG. 1 are not intended to limit the present invention. Indeed, other alternative hardware and/or software environments may be used without departing from the scope of the invention.

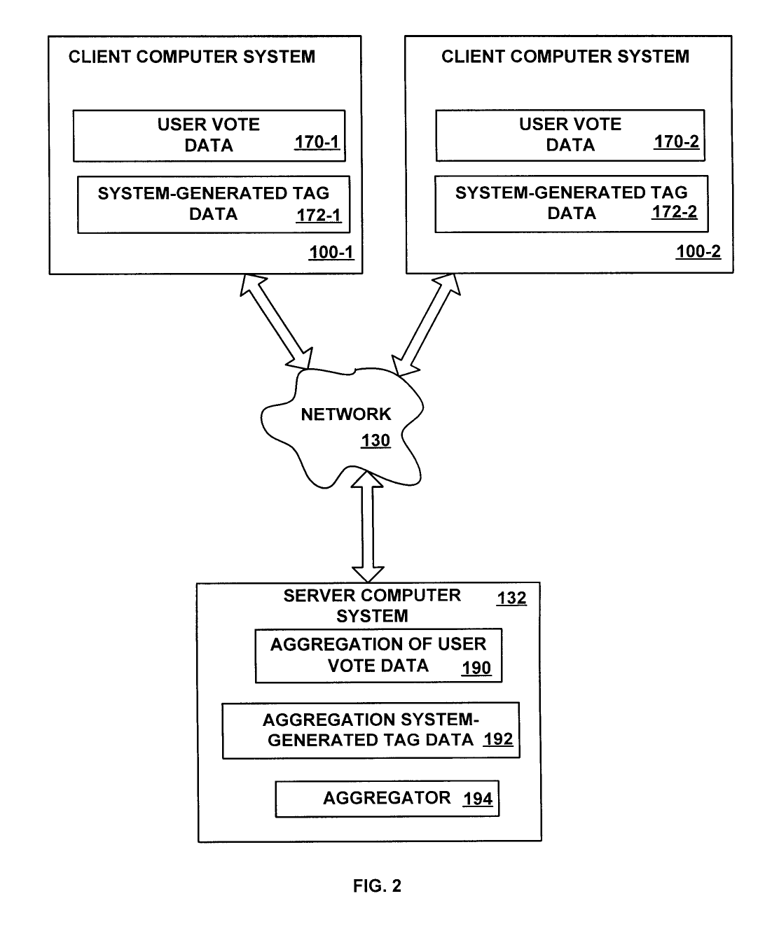

FIG. 2 depicts a block diagram of select components of an example network of systems for implementing an embodiment of the invention. FIG. 2 illustrates multiple client computer systems 100-1 and 100-2 connected to the server computer system 132 via the network 130, but in other embodiments any number of clients and servers may be present. The client computer system 100-1 includes user vote data 170-1 and system-generated tag data 172-1. The client computer system 100-2 includes user vote data 170-2 and system-generated tag data 172-2. The computer systems 100-1 and 100-2 are examples of the client computer system 100 (FIG. 1). The user vote data 170-1 and 170-2 are examples of the user vote data 170 (FIG. 1). The system-generated tag data 172-1 and system-generated tag data 172-2 are examples of the system-generated tag data 172 (FIG. 1). The aggregator 194 aggregates (unions, sums, or combines) the user vote data 170-1 and 170-2 into the aggregation of user vote data 190. The aggregator 194 aggregates (unions, sums, or combines) the system-generated tag data 172-1 and 172-2 into the aggregation of system-generated tag data 192 and sends the aggregation of user vote data 190 and the aggregation of system-generated tag data 192, or portions thereof, to the clients 100.

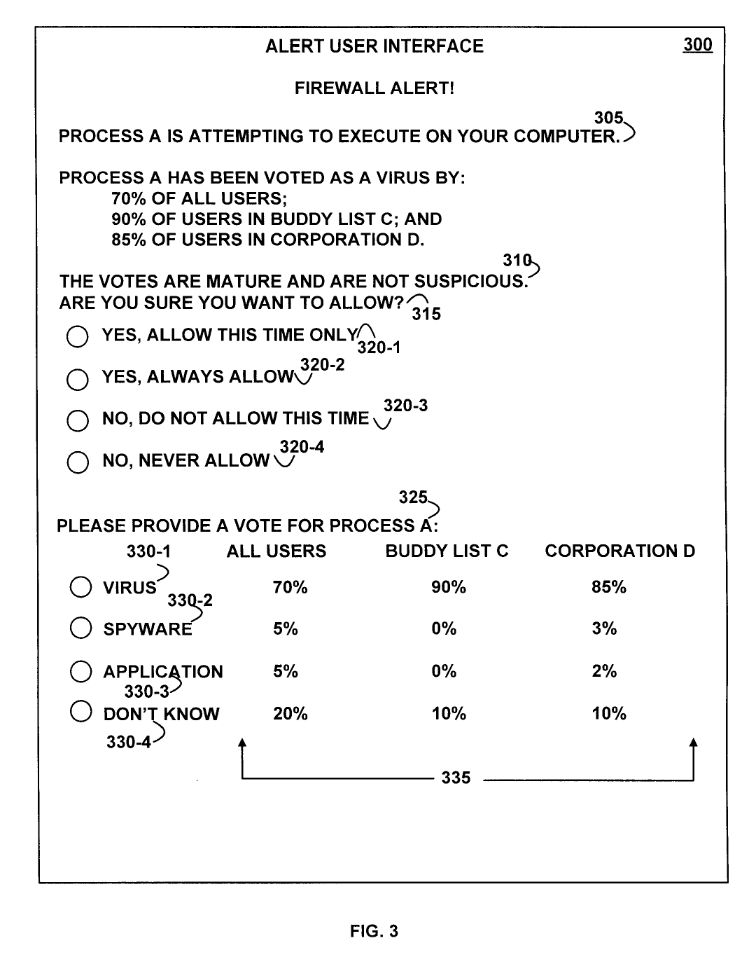

FIG. 3 depicts a block diagram of an example alert user interface 300, according to an embodiment of the invention. The user interface 300 may be presented to the user, e.g., via display on terminals 121, 122, 123, 124, but in other embodiments, the user interface 300 may be played via a speaker or presented via any appropriate data output technique. The firewall 150 presents the user interface 300 in response to detecting a process 174 attempting to execute on the processor 101 of the client computer system 100.

The user interface 300 includes an alert message 305 that indicates that an identified process 174 is attempting to execute on the processor 101 of the client 100. The user interface 300 further includes an indication of whether the votes are mature or suspicious 310. The firewall 150 makes the determination of whether the votes are mature or suspicious as further described below with reference to FIG. 10.

The user interface 300 further includes a request 315 for a decision as to whether the user desires to allow the process 174 to execute or be blocked from executing. The user interface 300 further includes decision input options 320-1, 320-2, 320-3, and 320-4, the selection of which allows the submission to the firewall 150 of a decision of whether to allow or block execution of the process 174. For example the option 320-1 provides the submission of a decision to allow the execution of the process for only the current execution; the option 320-2 provides the submission of a decision to allow the execution for the process for all attempted executions of the process; the option 320-3 provides the submission of a decision to block the execution of the process 174 for only the current attempted execution; and the option 320-4 provides the submission of a decision to block the execution of the process 174 for all attempted executions of the process 174.

The user interface 300 further includes a request 325 for a vote and vote input options 330-1, 330-2, 330-3, and 330-4. The vote input option 330-1 provides for the submission of a vote that the process 174 is a virus; the vote input option 330-2 provides for the submission of a vote that the process 174 is spyware; the vote input option 320-3 provides for the submission of a vote that the processor is an authorized application; and the vote input option 320-4 provides for the submission of a vote that the user does not know the category of the process. Thus, the vote input options 330-1, 330-2, 330-3, and 330-4 provide for the user to vote for the categories to which the process belongs. The vote input options are examples only, and any appropriate votes or categories of the process may be used. For example, in an embodiment, the vote input options may provide for submitting the opinion that the process is harmful versus not harmful. In other embodiments, the vote input options may provide for providing an opinion as to the category of the process, such an opinion of adware, a worm, a Trojan horse, or any other appropriate category. In another embodiment, a hierarchical method may be used to vote child processes associated with a parent process, for example all threads running under an application.

The user interface 300 further includes a presentation 335 of the aggregation of user vote data 190 (FIG. 1). The presentation 335 may divide the votes of users at other clients into communities 176 (FIG. 1). In various embodiments, the presentation 335 may include communities 176 to which the user belongs and communities 176 to which the user does not belong. The presentation 335 may present the aggregated votes of each community of users for each of the categories of processes.

In the example shown, the presentation 335 illustrates that 70% of the community of all users voted that the process belongs to the virus category, 5% of the community of all users voted that the process belongs to the spyware category, 5% of the community of all users voted that the process belongs to the authorized application category, and 20% of the community of all users voted that they do not know to which category the process belongs.

As a further example, the presentation 335 illustrates that 90% of the users who belong to the community of “buddy list c” voted that the process belongs to the virus category, 0% of the users who belong to the community of “buddy list c” voted that the process belongs to the spyware category, 0% of the users who belong to the community of “buddy list c” voted that the process belongs to the authorized application category, and 10% of the users who belong to the community of “buddy list c” voted that they do not know to which category the process belongs.

As a further example, the presentation 335 illustrates that 85% of the users who belong to the community of “corporation d” voted that the process belongs to the virus category, 3% of the users who belong to the community of “corporation d” voted that the process belongs to the spyware category, 2% of the users who belong to the community of “corporation d” voted that the process belongs to the authorized application category, and 10% of the users who belong to the community of “corporation d” voted that they do not know to which category the process belongs.

Although the presentation 335 illustrates the various percentages for each of the communities equaling 100%, in another embodiment the categories of processes need not be mutually exclusive.

FIG. 4 depicts a block diagram of an example data structure for the community data 176, according to an embodiment of the invention. A community is any group or set of users or clients 100. The community data 176 includes example community identifiers 176-1, 176-2, and 176-3. The community identifier 176-1 identifies a community of all users, the community identifier 176-2 identifies a community of “buddy list c,” and the community identifier 176-3 identifies a community of “corporation d.”

The community aspect of an embodiment of the invention is used to decrease the potential for malicious voting because users may join the communities 176, which the firewall 150 uses to aggregate votes within that community. This allows users to place more importance on the votes of those communities that they trust. In various embodiments, the communities may be private and, e.g., may require users to enter a password to join or may be public and allow any user to join. A private community prevents malicious users from masquerading as a trusted community member.

FIG. 5 depicts a block diagram of an example data structure for an aggregation of user vote data 190, according to an embodiment of the invention. The aggregation of user vote data 190 includes example records 505, 510, 515, 520, 525, 530, and 535, each of which includes an example process field 540, an example community identifier 545, a virus vote count 550, a spyware vote count 555, an application vote count 560, a “do not know” vote count 565, a mature indicator 570, and a suspect indicator 575. The process field 540 identifies a process 174. The process field 540 may include the name of the process 174, a signature of the process 174, a property of the binary code within the process 174, or any portion, combination, or multiple thereof. By using other properties of process identification instead of a name, if the process name changes but its properties stay the same, the votes from the old name are inherited. The community identifier 545 identifies a community 176. In an embodiment, a user may be a member of more than one community, in which case that user's vote may be reflected in multiple of the records in the aggregation of the user vote data 190.

The virus vote count 550 indicates the number of users who belong to the community 545 who have voted that the process 540 is a virus (the virus vote count 550 is the aggregation of the virus votes from the community 545). In another embodiment, the virus vote count 550 may indicate the percentage of the users in the community 545 who have voted that the process 540 is a virus. The spyware vote count 555 indicates the number of users who belong to the community 545 who have voted that the process 540 is spyware (the spyware vote count 555 is the aggregation of the spyware votes from the community 545). In another embodiment, the spyware vote count 555 may indicate the percentage of the users in the community 545 who have voted that the process 540 is spyware. In another embodiment, instead of separate categories of harmful processes (e.g. virus and spyware), the vote count may simply indicate that the process is harmful or not harmful. In an embodiment, categories may be hierarchically defined based on other categories. For example, a harmful category (a parent category) may include virus, spyware, and adware categories (child categories), with the harmful vote count (the parent vote count) being the total of the virus, spyware, and adware vote counts (the child vote counts). When presented to the user, the firewall 150 may optionally hide or display the parent or child categories and vote counts, depending on the level of detail desired. Hierarchical categories have the advantage that different users may categorize the same process differently while still agreeing that the process is harmful (or not harmful).

The application vote count 560 indicates the number of users who belong to the community 545 who have voted that the process 540 is an authorized application or is not harmful (the application vote count 560 is the aggregation of the application votes from the community 545). In another embodiment, the application vote count 560 may indicate the percentage of the users in the community 545 who have voted that the process 540 is an application. The “do not know” vote count 565 indicates the number of users who belong to the community 545 who have voted that they do not know how to categorize the process 540 or they do not know whether the process 540 is harmful (the “do not know” vote count 565 is the aggregation of the “do not know” votes from the users who belong to the community 545).

The mature indicator 570 indicates whether the vote counts are high enough to be mature and reliable. The suspect indicator 575 indicates whether the accuracy of the vote counts is suspicious. Although the mature indicator 570 and the suspect indicator 575 are illustrated as having binary values (e.g., yes/no or true/false), in another embodiment one or both may have a range of values indicating a probability or likelihood that the vote counts are mature or suspect.

FIG. 6 depicts a block diagram of an example data structure for an aggregation of system-generated tag data 192, according to an embodiment of the invention. The aggregation of system-generated tag data 192 includes example records 605, 610, 615, and 620, each of which includes an example file identifier field 625, a source type field 630, a source identifier field 635, a runtime data field 640, and a process identifier field 645. The file identifier field 625 identifies a file 180. The source type field 630 indicates the type, protocol or delivery technique for receiving the associated file 625. For example, in record 605, the source type 630 of the file 625 of “file A” is an email attachment; in record 610, the source type 630 of the file 625 of “file B” is a point-to-point application protocol; in record 615, the source type 630 of the file 625 of “file C” is file transfer protocol; and in record 620, the source type 630 of the file 625 of “file A” is a download.

The source identifier field 635 identifiers the sender (e.g., the network address) that sent the file 625 via the source type 630 delivery technique. The runtime data field 640 indicates actions that the process 645 took or data that the process 645 generated or accessed. The process identifier field 645 identifies the process or processes that saved the file 625 at various clients.

FIG. 7 depicts a block diagram of example rules 178, according to an embodiment of the invention. The firewall 150 uses the rules 178 to control whether the processes 174 are allowed to execute on the processor 101 or are blocked from executing. In various embodiments, multiple of the rules may work in conjunction, and rules may be either simple or complex. The rules may be distributed across the network 130 to various of the clients 100, e.g., across a corporate network to all of its clients. Additionally, sets of the rules 178 may be used together in a defined profile, which allows users to toggle between greater or lesser amounts of security depending upon their situation. For example, a client 100 may use one set of rules when connected to an internal intranet of the user's employer, but may use a different set of rules when connected to a wireless network via a public hotspot.

In various embodiments, the rule 178 may specify a process, a group of processes, or criteria for selecting processes to which the rule applies. The criteria may include, e.g., counts or percentages of votes that the process must have received from specified communities, categories to which the process must belong, data content of the processes, logical operators, any other appropriate criteria, or any multiple, combination, or portion thereof that must be met in order for the process to satisfy the rule. The rules 178 may further specify a blocking or allowing action that the firewall 150 is to take for processes that meet the criteria and a time period or number of occurrences for taking the action.

The example rules 178 illustrated in FIG. 7 are the rule 178-1 “always block process C,” the rule 178-2 “never block process D,” the rule 178-3, “block (processes downloaded from email) containing (subject line “image” and “open”) and voted (>20% “virus” by community corporation A) or voted (>30% “virus” by all users), the rule 178-4 “allow process E to execute and log its actions,” and the rule 178-5 “allow process F to execute, but deny network access.” The rules 178 may include conditions, which the firewall 150 enforces. Example conditions include the condition 705, which causes the firewall 150 to log the actions of the specified process, and the condition 710, which causes the firewall 150 to deny the specified process access to the network 130.

FIGS. 8A and 8B depict flowcharts of example processing for the firewall 150 that has detected a process 174 attempting to execute, according to an embodiment of the invention. Control begins at block 800. Control then continues to block 805 where the firewall 150 detects a process attempting to execute on the process 101. Control then continues to block 806 where the firewall 150 determines whether the detected process satisfies multiple of the rules 178 whose results conflict with each other. The rules 178 conflict for a process if two or more rules provide different results: the result of allowing the process to execute versus the result of blocking the process from executing. For example, a rule that allows processes to execute that are voted as an application by 80% of users belonging to the “buddy list c” community may conflict with the rule 178-3 (FIG. 7) for some processes and some vote counts.

If the determination at block 806 is true, then the detected process satisfied multiple of the rules 178 that conflict, so control continues to block 807 where the firewall 150 presents an error message, e.g., that identifies the process and the conflicting rules, and optionally blocks the detected process from executing until the rule conflict is resolved. In another embodiment, the firewall 150 may request a decision from the user whether to allow the process to execute. Control then returns to block 805, as previously described above.

If the determination at block 806 is false, then the detected process does not satisfy multiple rules that conflict, so control continues to block 810 where the firewall 150 finds a rule 178 associated with the detected process 174 based on an identifier of the process 174 (e.g., the process name, signature, or properties) and determines whether the detected process 174 satisfies a rule 178 that indicates that the process is to be blocked from executing on the processor 101.

If the determination at block 810 is true, then the rule 178 indicates that the process 174 is to be blocked from executing on the processor 101 at the client 100, so control continues to block 815 where the firewall 150 blocks the process 174 from executing on the processor 101 at the client 100. Control then continues to block 820 where the firewall 150 determines whether a user has provided a vote for the process 174.

If the determination at block 820 is true, then the user has provided a vote for the process 174, so control continues to block 825 where the firewall 150 determines whether the process 174 satisfies a rule 178 that indicates the process is allowed to execute.

If the determination at block 825 is true, then the rule 178 indicates that the process 174 is allowed to execute on the processor, so control continues to block 830 where the firewall 150 allows the process 174 to execute on the processor 101 and enforces any optional conditions specified in the rule 178, such as logging actions of the process 174 and denying network access by the process 174. Control then returns to block 805, as previously described above.

If the determination at block 825 is false, then the rule 178 does not indicate that the process 174 is allowed to execute, so control continues to block 835 where the firewall 150 presents the alert and the aggregation of user vote data 190 and the aggregation of system-generated tag data 192 and requests the user for a decision of whether to allow the process 174 to execute at the client. Control then continues to block 840 where the firewall 150 determines whether the user granted permission to execute the process 174.

If the determination at block 840 is true, then in the received decision the user granted permission to execute the process 174, so control continues to block 845 where the firewall 150 allows the process 174 to execute and if the decision of the user specifies that the process 174 is always allowed to execute, then the firewall 150 adds or creates a rule indicating that the process 174 is always allowed to execute to the rules 178. Control then returns to block 805, as previously described above.

If the determination at block 840 is false, then control continues to block 850 where the firewall 150 blocks the process 174 from executing on the processor 101 and adds or creates a rule to the rules 178 that specifies the process 174 is always to be blocked if the received decision indicates that the process 174 is always to be blocked. Control then returns to block 805, as previously described above.

If the determination at block 820 is false, then the user has not already provided a vote for the process 174, so control continues to block 855 where the firewall 150 presents the alert user interface (e.g., the alert user interface of FIG. 3), which may include the presentation 305 of the alert message, the presentation 310 of the mature and/or suspicious notification, the presentation 315 of the request for a decision of whether to allow the process 174 to execute at the client, the presentation 325 of a request for a user vote for the process, and the presentation 335 of the aggregation of user vote data 190 categorized by communities to which the plurality of users belong. The aggregation of user vote data 190 presented represents votes provided by users associated with the clients at which the detected process attempted to execute. The processing of block 855 occurs in response to the detecting the process attempting to execute (at block 805). The firewall 150 receives the decision of whether to allow the process 174 to execute.

Control then continues to block 860 where the firewall 150 optionally receives the user vote data 170 regarding the process in response to the previous presentation of the aggregation of user vote data (block 855) and sends the user vote data 170 and the communities 176 to which the user belongs to the server 132. Control then continues to block 840, as previously described above.

If the determination at block 810 is false, then a rule 178 that specifies the detected process 174 does not indicate that the process 174 is to be blocked, so control continues to block 820, as previously described above.

FIG. 9 depicts a flowchart of example processing for the firewall 150 in response to the saving of a file 180, according an embodiment of the invention. Control begins at block 900. Control then continues to block 905 where the firewall 150 detects a file 180 being saved at the client computer system 100, e.g., in the memory 102 or the disk drives 125, 126, or 127.

Control then continues to block 910 where the firewall 150 creates the system-generated tag data 172. Control then continues to block 915 where the firewall 150 sends the system-generated tag data 172 to the server 132. Control then continues to block 920 where the aggregator 194 adds the system-generated tag data 172 to the aggregation of system-generated tag data 192. Control then continues to block 925 where the aggregator 194 sends the aggregation of system-generated tag data 192 to the client 100. Control then continues to block 930 where the firewall 150 presents the aggregation of system-generated tag data 192 to the user.

Control then continues to block 935 where the user creates the rules 178 based on the presentation of the aggregation of system-generated tag data 192. Control then continues to block 999 where the logic of FIG. 9 returns.

FIG. 10 depicts a flowchart of example processing for the user vote data 170, according an embodiment of the invention. Control begins at block 1000. Control then continues to block 1005 where the aggregator 194 receives the user vote data 170 and the community data 176 from the client 100. Control then continues to block 1010 where the aggregator 194 adds the received vote data 170 to the aggregation of user vote data 190, categorizing the vote data by the communities 176. Control then continues to block 1015 where the aggregator 194 determines whether the percentage of users in a community have submitted the user vote data 170 for the process 174 is greater than a threshold.

If the determination at block 1015 is true, then the percentage of users in a community that have submitted user vote data 170 for the process 174 is greater than the threshold, so control continues to block 1020 where the aggregator 194 sets the mature field 570 in the record associated with the community and the process 174 to indicate that record in the aggregation of user vote data 190 is mature.

Control then continues to block 1025 where the aggregator 194 determines whether the aggregation of user vote data 190 is suspicious. In various embodiments, the aggregator 194 determines that the aggregation of user vote data 190 is suspicious based on the clients 100 that submitted the user vote data 170, e.g., the network addresses of the clients 100, the number of votes submitted by the clients 100, the communities to which the clients 100 belong or do not belong, or the degree to which the votes of the clients 100 match the votes from other clients or other clients in the same or different communities. The aggregator 194 may use a threshold, or any number of thresholds, to determine whether the aggregation of user vote data 190 is suspicious. For example, if a first network address submits multiple votes for the same process and a second network address also submits multiple votes for the same process, then the aggregator 194 may add the number of multiple votes together, and if the total number of multiple votes submitted by both the first and second network addresses exceeds a multiple-vote threshold, then the aggregation of user vote data 190 record for that process and community is suspicious.

If the determination at block 1025 is true, then the aggregation of user vote data 190 is suspicious, so control continues to block 1030 where the aggregator 194 sets the suspect field 575 in the record associated with the community and the process 174 to indicate that the aggregation of user vote data 190 for that record is suspicious. Control then continues to block 1035 where the aggregator 194 sends the aggregation of user vote data 190 to the firewall 150. Control then continues to block 1040 where firewall 150 receives the aggregation of user vote data 190. Control then continues to block 1099 where the logic of FIG. 10 returns.

If the determination at block 1025 is false, then the aggregation of user vote data 190 is not suspicious, so control continues to block 1045 the aggregator 194 sets the suspect field 575 in the record associated with the community and the process 174 to indicate that the aggregation of user vote data 190 is not suspicious. Control then continues to block 1035, as previously described above.

If the determination at block 1015 is false, then the percentage of users in a community that have submitted user vote data 170 for the process 174 is not greater than the threshold, so control continues to block 1050 where the aggregator 194 sets the mature field 570 in the record associated with the community and the process 174 to indicate that the aggregation of user vote data 190 is not mature. Control then continues to block 1025, as previously described above.

In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments were described in sufficient detail to enable those skilled in the art to practice the invention, but other embodiments may be utilized and logical, mechanical, electrical, and other changes may be made without departing from the scope of the present invention. Different instances of the word “embodiment” as used within this specification do not necessarily refer to the same embodiment, but they may. Any data and data structures illustrated or described herein are examples only, and in other embodiments, different amounts of data, types of data, fields, numbers and types of fields, field names, numbers and types of records, entries, or organizations of data may be used. In addition, any data may be combined with logic, so that a separate data structure is not necessary. The previous detailed description is, therefore, not to be taken in a limiting sense, and the scope of the present invention is defined only by the appended claims.

In the previous description, numerous specific details were set forth to provide a thorough understanding of the invention. But, the invention may be practiced without these specific details. In other instances, well-known circuits, structures, and techniques have not been shown in detail in order not to obscure the invention.

What is claimed is:

1. A method comprising:
blocking a process from executing at a client if the process satisfies a rule indicating that the process is to be blocked;
allowing the process to execute at the client if the process satisfies a rule indicating that the process is to execute;
requesting a vote for the process from a user associated with the client; and
presenting an aggregation of a plurality of votes associated with the process, wherein the plurality of votes were provided by a plurality of users associated with a plurality of clients at which the process attempted to execute.

2. The method of claim 1, further comprising:
requesting a decision of whether to allow the process to execute at the client in response to the presenting.

3. The method of claim 2, further comprising:
creating the rule based on the decision.

4. The method of claim 1, wherein the requesting the vote further comprises:
requesting the vote associated with the process from the user if the user has not yet provided the vote, wherein the requesting is in response to detecting that the process attempts to execute at the client.

5. The method of claim 1, wherein the allowing the process to execute at the client further comprises:
enforcing a condition of the rule indicating the process is to execute.

6. The method of claim 1, wherein the vote comprises an opinion of whether execution of the process at the client is harmful.

7. The method of claim 1, wherein the vote comprises an opinion of a category to which the process belongs.

8. The method of claim 1, wherein the presenting further comprises:
presenting the aggregation of the plurality of votes categorized by communities to which the plurality of users belongs.

9. The method of claim 1, further comprising:
adding the vote from the user to the aggregation of the plurality of votes.

10. The method of claim 1, wherein the presenting further comprises:
presenting an indication of whether the aggregation of the plurality of votes is mature; and
presenting an indication of whether the aggregation of the plurality of votes is suspicious.

11. A signal-bearing medium encoded with instructions, wherein the instructions when executed comprise:
blocking a process from executing at a client if the process satisfies a rule indicating that the process is to be blocked;
allowing the process to execute at the client if the process satisfies a rule indicating that the process is to execute;
requesting a vote for the process from a user associated with the client, wherein the requesting the vote further comprises requesting the vote associated with the process from the user if the user has not yet provided the vote, wherein the requesting is in response to detecting that the process attempts to execute at the client;
presenting an aggregation of a plurality of votes associated with the process, wherein the plurality of votes were provided by a plurality of users associated with a plurality of clients at which the process attempted to execute; and
requesting a decision of whether to allow the process to execute at the client in response to the presenting.

12. The signal-bearing medium of claim 11, further comprising:
creating the rule based on the decision.

13. The signal-bearing medium of claim 11 wherein the allowing the process to execute at the client further comprises:
enforcing a condition of the rule indicating the process is to execute, wherein the condition is selected from a group consisting of logging actions of the process and denying network access by the process.

14. The signal-bearing medium of claim 11, wherein the vote comprises an opinion of whether execution of the process at the client is harmful.

15. The signal-bearing medium of claim 11, wherein the vote comprises an opinion of a category to which the process belongs.

16. A method for configuring a computer, comprising:
configuring the computer to block a process from executing at a client if the process satisfies a rule indicating that the process is to be blocked;
configuring the computer to allow the process to execute at the client if the process satisfies a rule indicating that the process is to execute, wherein the configuring the computer to allow the process to execute at the client further comprises configuring the computer to enforce a condition of the rule indicating the process is to execute, wherein the condition is selected from a group consisting of logging actions of the process and denying network access by the process;
configuring the computer to request a vote for the process from a user associated with the client, wherein the configuring the computer to request the vote further comprises requesting the vote associated with the process from the user if the user has not yet provided the vote, wherein the requesting is in response to detecting that the process attempts to execute at the client;
configuring the computer to present an aggregation of a plurality of votes associated with the process, wherein the plurality of votes were provided by a plurality of users associated with a plurality of clients at which the process attempted to execute; and
configuring the computer to request a decision of whether to allow the process to execute at the client in response to the presenting.

17. The method of claim 16, wherein the vote comprises an opinion of whether execution of the process at the client is harmful.

18. The method of claim 16, wherein the vote comprises an opinion of a category to which the process belongs.

19. The method of claim 16 wherein the configuring the computer to present further comprises:
configuring the computer to present the aggregation of the plurality of votes categorized by communities to which the plurality of users belongs;
configuring the computer to present an indication of whether the aggregation of the plurality of votes is mature; and
configuring the computer to present an indication of whether the aggregation of the plurality of votes is suspicious.

20. The method of claim 16, further comprising:
configuring the computer to receive an aggregation of tag data associated with the process, wherein the tag data was generated at the plurality of clients in response to saving of a file, and wherein the tag data is selected from a group consisting of a source type of the file, an identifier of the source of the file, and runtime data of the process; and
configuring the computer to create the rule based on the aggregation of the tag data.
